(19) United States
(12) Patent Application Publication
(10) Pub. No.: US 2013/0282395 A1
(43) Pub. Date: Oct. 24, 2013

(54) MEDICAL REGISTRY

(71) Applicants: Naryan L. Rustgi, Villanova, PA (US); Sanjay Kumar Kunchakarra, Clarksville, MD (US)

(72) Inventors: Naryan L. Rustgi, Villanova, PA (US); Sanjay Kumar Kunchakarra, Clarksville, MD (US)

(21) Appl. No.: 13/920,100

(22) Filed: Jun. 18, 2013

(51) Int. Cl. G06Q 50/22; G06Q 10/06

(52) U.S. Cl. CPC G06Q 50/22; G06Q 10/06
USPC 705/2

(57) ABSTRACT

An embodiment relates to a system for correlating medical data, the system comprising: a module configured to collect patient inputted data provided by a patient; a module configured to collect data from an existing data bank; a storage medium for storing data collected from a plurality of modules; and at least one processor configured to correlate the patient inputted data with data from one or more databases.

### 1. BACKGROUND

Several databases for capturing research associated with cancer exist in the medical research industry.

### 2.0 SUMMARY

Medical Registry such as a Cancer Registry enables the following:
Capture data directly from patients throughout the life cycle i.e., from disease diagnosis, treatment and post treatment life style information
Collect information from existing knowledge and clinical trial databases
Collect information from Doctor's office patient medical records(although, patient data may need to be de-identified and internal review boards may be needed to validate and authenticate the patient data)
Combine and correlate data all of the above three sources

The data from clinical trials and other research studies includes only a limited set of patients. However, a Cancer Registry, for example, potentially could contain data associated with several millions patients. The database that contains patients' data in such large numbers provides a unique opportunity to develop and continuously refine medical diagnosis, therapy and management, for example, for cancer, as well as treatment models including effectiveness of various treatment drugs.

In addition, the Medical Registry offers the following features to patients:
Connect and enable patients to search on case studies of patients with similar profiles
Interact and collaborate with patients of similar interest through social media platforms
Provide personalized recommendations to patients on lifestyle patterns including diet, exercise and stress relief mechanisms during the post treatment recovery process
Provide patients with an early detection system that cross references the patient's medical condition with new studies and publications

Medical Registry will be an extremely useful platform for researchers as well as doctors providing the following services:
Provide tools and platform to analyze patients data by research scientists
Provide tools and platform to collaborate on disease mitigation

### 3.0 BRIEF DESCRIPTION OF FIGURES

FIG. 1: Depicts an illustrative schematic of the high level components associated with Medical Registry such a Cancer Registry according to an embodiment.

FIG. 2: Depicts an illustrative schematic of the patient, researcher or doctor registry input according to an embodiment.

FIG. 3: Depicts an illustrative schematic of undesirable data mitigation system according to an embodiment according to an embodiment.

FIG. 4: Depicts an illustrative schematic of the logical system architecture of Medical Registry such as the Cancer Registry according to an embodiment.

FIG. 5: Depicts an illustrative schematic of the patient service functional architecture according to an embodiment.

FIG. 6: Depicts an illustrative schematic of the patient lifestyle recommendation service of Medical Registry such as the Cancer Registry according to an embodiment.

FIG. 7: Depicts an illustrative schematic of the patient matching service of Medical Registry such as the Cancer Registry according to an embodiment.

FIG. 8: Depicts an illustrative schematic of layered breakdown of researcher services of Medical Registry such as the Cancer Registry according to an embodiment.

FIG. 9: Depicts an illustrative schematic of the technical architecture of Medical Registry such as the Cancer Registry according to an embodiment.

### 4.0 DETAILED DESCRIPTION

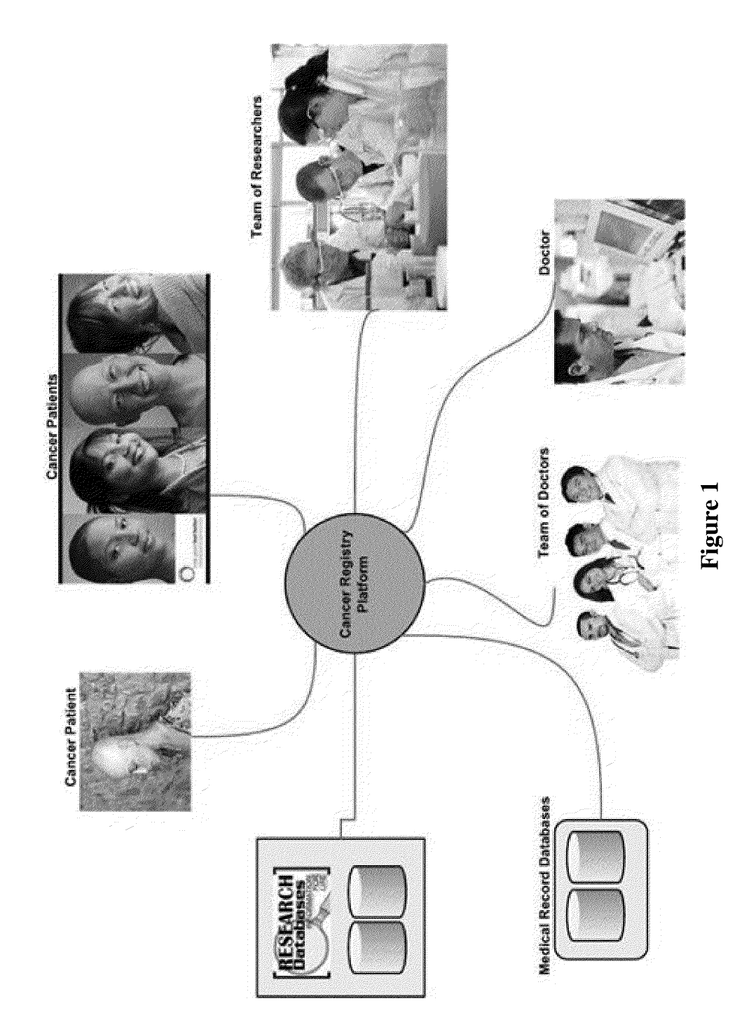

As shown in FIG. 1, the following types of users interact with Medical Registry such as the Cancer Registry Platform:

a) Patients such Cancer Patients

b) Scientists such as Cancer Research Scientists

c) Health Care Providers including Doctors

Below we describe a Medical Registry for cancer.

### Cancer Patient Interaction:

A patient is able to access the platform by inputting their credentials, which are then authenticated to allow access. Once the patient has entered the platform, they can enter their data and optionally use the platform's social network capabilities to interact with other individuals who may be experiencing similar symptoms or illnesses as them. In addition, Cancer Registry provides personalized lifestyle recommendations.

### Cancer Research Scientists:

Cancer Registry Platform enables the scientists to enter data and search, analyze and correlate the data from three distinct sources including Cancer Registry's Patients data, external Cancer Research Repositories and Cancer Patients medical records from doctor's office.

### Health Care Providers:

Cancer Registry Platform enables the doctor's and other health care providers to enter data and perform searches and understand patients' feedback on various treatment technologies. In addition, it provides a wealth of information on lifestyle recommendations that can be prescribed to patients during the post treatment recovery periods.

### Patients Data Capture Flow:

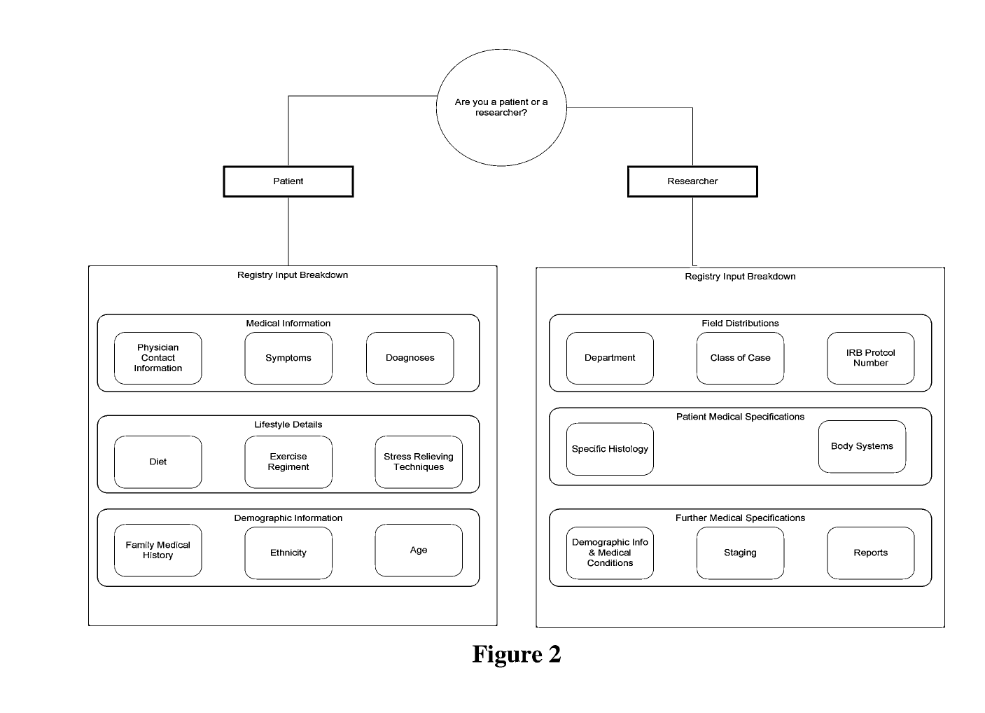

The information that every patient inputs, for example, to create their profile within the social network platform, such as demographic information and medical history, is referred to as structured patient reported data and is stored in a database within Medical Registry such the cancer registry platform. The information that patients provide, for example, in the social network, through comments and discussions is known as unstructured patient reported data as seen in FIG. 2.

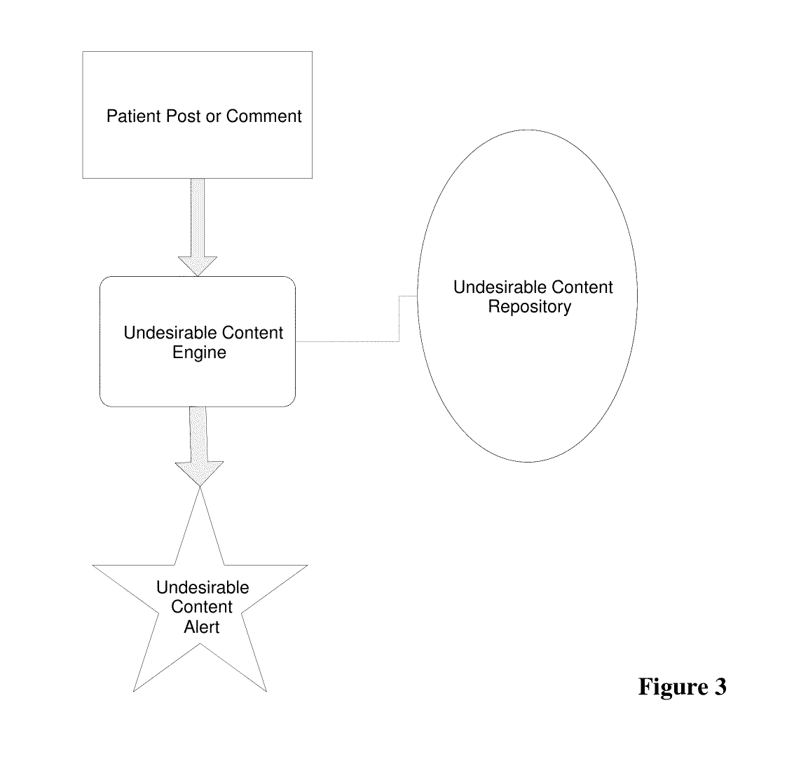

As the primary source of data for the platform, the patient reported data has the potential for extreme error because it is impossible to control the patient's understanding and judgment in what they report. However this platform will have the capability of filtering to some extent both the structured and unstructured patient reported data. The flowchart depicted in FIG. 3 illustrates the method for detecting unreliable unstructured patient reported data. Any time a patient publishes a status or comments on a post through, for example, the platform's social network capabilities, they gain the ability to influence others. But because these patients are not trained medical professionals, their advice is not always sound. The method above relies on a pre-existing set of undesirable words or phrases such as “smoking reduces the risk of cancer.” The text in every comment or post is analyzed and cross-referenced with the undesirable phrases data set to determine if the post contains fallacious information. If an undesirable phrase is detected within the post, the post will be flagged to signal other users that the information contained within the post is erroneous.

The platform will also have the capability of monitoring and filtering structured patient data as well. When patients are inputting their demographic information and their medical condition, pre-programmed limitations, which are boundaries that define a framework of the medical registry input service, will be implemented. For example, if a person labels himself as male, the platform will not allow the patient to say that he has ovarian cancer. Limitations such as these ensure that illogical data is not entered into the database and used for analytical purposes.

### Conceptual Architecture:

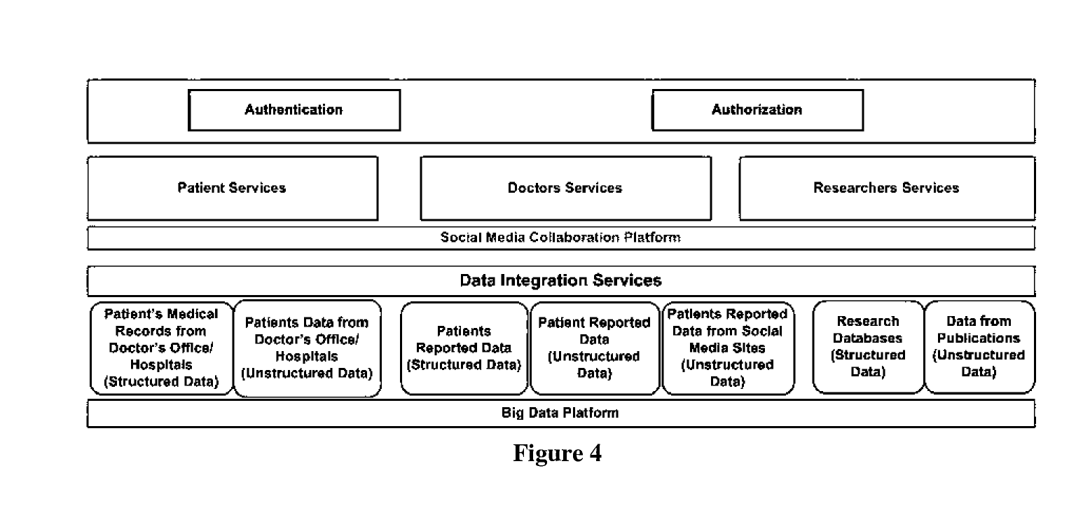

FIG. 4 provides a layered breakdown of the cancer registry platform. The initial step is the authentication of every user. Whether you are a patient, physician, researcher, non-physician health-care provider, or insurance provider, every person enters his or her credentials into the platform. Those credentials are then authenticated providing the user with access to the platform.

The platform is separated into at least three different service segments, a patient services segment, a doctor services segment, and a researcher services segment. Optionally, there could be an insurance provider service segment. A service segment is a grouping of applications specified to one type of user. Based on what type of user you are, you will be provided with a specific set of services. Patients will also be able to communicate with one another through the social media platform (for example by blogging and any future derivatives of blogging), and they will have applications within the platform that services just them. Similarly, doctors will be able to interface with one another, but will have individualized applications available to them. Researchers will be able to communicate with their peers personally as well as professionally as they will get updates of their peer's research activity, such as publishing a study or beginning a drug trial. Researcher Services will primarily consist of analytic tools that combine information from the multitude of data sources within the platform to illustrate trends in disease development or occurrences of drug side effects appearing across an extremely large population.

The data used for the above mentioned services segments are integrated through data integration services. The primary sources of data that the data integration services will use to power the patient, doctor, and researcher services are the structured and unstructured patient reported data, structured and unstructured research data, and structured and unstructured medical data. The structured patient reported data is all the information that patients input when answering the registry questionnaire questions (i.e. demographic info and medical history). There are two sources of unstructured patient data. One being self-reported diagnoses that cannot be considered entirely accurate and the other being all the information accumulated throughout the social network through patient conversations, comments and monitored activity. Structured doctor reported data is essentially all the information doctors input regarding official patient records. Unstructured doctor reported data would come from extracted comments and conversations physicians have on the social media platform. Structured Researcher data is all the information contained within the research database such as publications and studies from academic institutions around the world and current databases.

All the information compiled and gathered is stored within a Big Data Platform. When an application in the patient, doctor, or research services is launched, data is extracted from the big data platform and is analyzed for a specific task through the data integration service. The output information will be relayed back to the patient, doctor, or researcher.

Both the unstructured and structured patient reported data is analyzed and cross referenced with information from other databases. For example, the other databases could include current research and academic databases such as PubMed. The patient reported data is used to power an engine that searches for publications relevant to the patient's condition. The publications that are identified are then provided to the patient as suggested reading. The patient reported data regarding medical history and symptoms are verified to a degree by cross-referencing them with another database storing physicians' medical records.

When a patient creates an account for the first time, a unique object will be created for the patient, which is stored in the registry database. Similarly, when a physician enters information regarding a specific patient, a unique object is created which is stored in the medical record database (structured doctor data). The main platform will then compare the attributes of the two corresponding objects and create an alert if there is a discrepancy.

Optionally, just like the patients gain access to their own social networking platform, physicians and researchers will also have the ability to interact with their peers in same or different social networking platforms. Within asocial networking platform, three account types can be available, one for patients, one for physicians, and one for researchers. Researchers will be able to observe what recent studies and publications their peers in similar research settings have completed, increasing the flow of communication between research organizations around the world.

### Patient Services

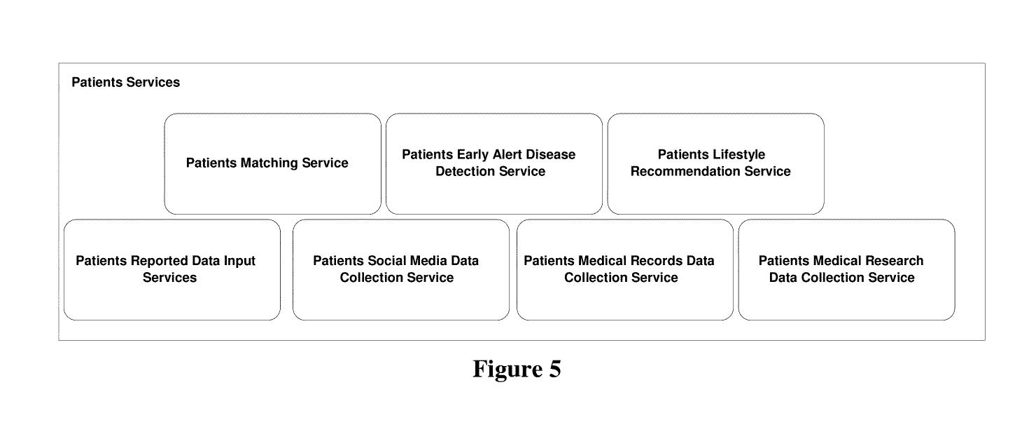

FIG. 5 provides a deeper look into the patient services as touched on before. As previously mentioned when a patient logs on to the platform, they will have access to both a social media platform and individualized services. The components of these individualized services are, for example, a lifestyle recommendation service and a patient matching service, which are powered by the patient reported data (structured and unstructured), the structured doctor reported data (medical records), and the structured research data (medical databases).

An embodiment of the patient services is the Lifestyle recommendation service, which will be expanded on further. Essentially this engine will pull information from the patient reported database, research publications, and medical records to provide patients facing medical issues with a comprehensive lifestyle regiment that includes a specified diet, exercise, and stress relieving techniques that help patients recover and deal with illnesses beyond prescribed medication.

Another embodiment of the patient services is the Patients Matching service. The patient matching service essentially provides each patient with profiles of others who are experiencing similar symptoms or illnesses. One purpose of this service is to simply establish communication channels between individuals who may want to talk with others who are going through the same medical conditions and procedures that they are such as chemotherapy or transplants. These social channels provide patients with much needed comfort as they begin physically exhausting medical procedures. Patients who have yet to receive a diagnosis for their symptoms can be paired with others who are experiencing similar symptoms. If a patient discovers somebody in a similar situation they are in who has been diagnosed with a certain disease, it could provide that patient with an idea of what could be causing his or her symptoms. This allows patients access to the wealth of data within this registry, which can be used as a potential differential diagnosis system for a patient unable to find a suitable diagnosis from conventional doctors. The matching service pulls from the patient reported data and from doctor reported data in medical records to check for similarities in demographics and symptoms between patients.

Another embodiment of the patient services is an early detection system that alerts patients when they may have a certain illness. This engine compiles the structured and unstructured patient reported data and cross-references it with new medical studies that illustrate potential relationships between diseases. For example, if a person says that he has diabetes and says that he is beginning to experience high blood pressure and high cholesterol, an alert will be provided to the patient informing him that due to his condition of diabetes and the fact that these symptoms have signaled heart conditions in other patients, this person may be at risk for heart disease.

### Patient Lifestyle Recommendation Service

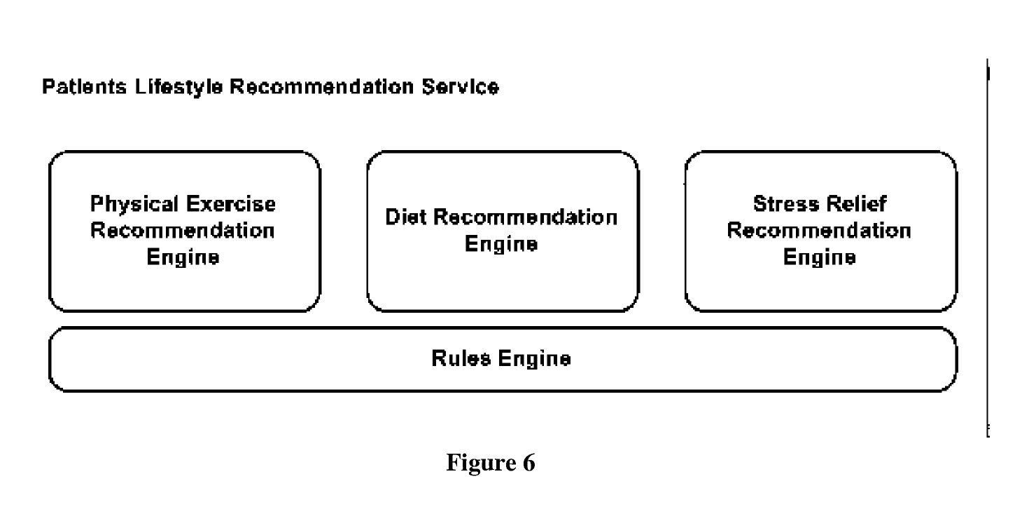

The goal of the patient's lifestyle recommendation engine is to provide patients with a holistic set of guidelines to live by during disease recovery. Once a patient is released from the hospital or are trying to cope with a disease, often they aren't given much instruction on how to appropriate eat, exercise, etc. in order to keep their body healthy and prevent other diseases from surfacing. Once patients input their symptoms and/or diagnoses along with completing a personality questionnaire, the engine provides the patients with exercise regiments, dietary guidelines, and stress relief techniques, each individualized to the patient's particular conditions and personality traits as depicted in FIG. 6.

The first mechanism that provides patients with an individualized lifestyle recommendation is the extraction of information from the medical publications database. As new studies are being published illustrating how, for example, certain forms of exercise can help in the recovery from heart cancer, the lifestyle recommendation engine compiles these studies to create an algorithm that controls the rules engine. If a patient enters in their demographic information, claiming that he is a middle-aged male with heart disease, the rules engine will take those pieces of information (male, middle-aged, and heart disease) and utilize the preset algorithm to generate an appropriate exercise and diet regiment for the patient.

The second mechanism used to generate a lifestyle recommendation is the extraction of information from the physician records database. Along with just the patients demographic data, doctors can also add in notes or suggestions they have regarding the patients exercise or dietary habits. For example, a physician might note, if his patient had problems with heart disease, to avoid eating too much red meat. All the notes and suggestions that doctors include will be synthesized to increase the capabilities of the rules engine. Instead of simply generating exercise and diet regiments through relationships identified in biological studies, the entirety of physicians' notes in the records database will be complied to establish relationships between medical condition and exercise/dietary requirements (i.e., patients with heart disease shouldn't eat red meat).

The third mechanism used to generate recommendation output is through the analysis of patient reported data. The analysis of unstructured patient reported data (i.e. comments and thread discussions) can also illustrate relationships between medical condition and exercise/diet/stress relieving techniques. As opposed to the analysis of controlled medical experiments or suggestions provided by qualified professionals, patient reported data can be erroneous and requires methods of filtration to ensure quality results. However, the mass of data itself is extremely powerful and harnessing it to detect Trends or relationships that may not appear in small controlled experiments can yield results that will advance the rules engine.

The patient lifestyle recommendation engine will also be implemented with a self-improvement system. When the engine initially outputs dietary/exercise/stress relieving regiments based on the patients' initial input, the engine will then later record the patient's change in medical condition to evaluate the effectiveness of the provided treatment. Doing so will self-correct the algorithm used to generate lifestyle recommendations.

### Patient Matching Service

One feature of the platform is a service that links patients together based on medical condition and symptoms. This service is used for medical or social purposes to allow for those experiencing similar medical issues to talk with one another about how they deal with the situation. This technology can also be used to link patients up that have not received a diagnosis yet but are experiencing similar symptoms. Often times, rare occurrences of diseases are difficult to pin point, but if a large mass of people are located in one place, and a common symptom is found amongst several people, it could help understand what underlying disease is causing the symptom, speeding up the process of receiving a diagnosis.

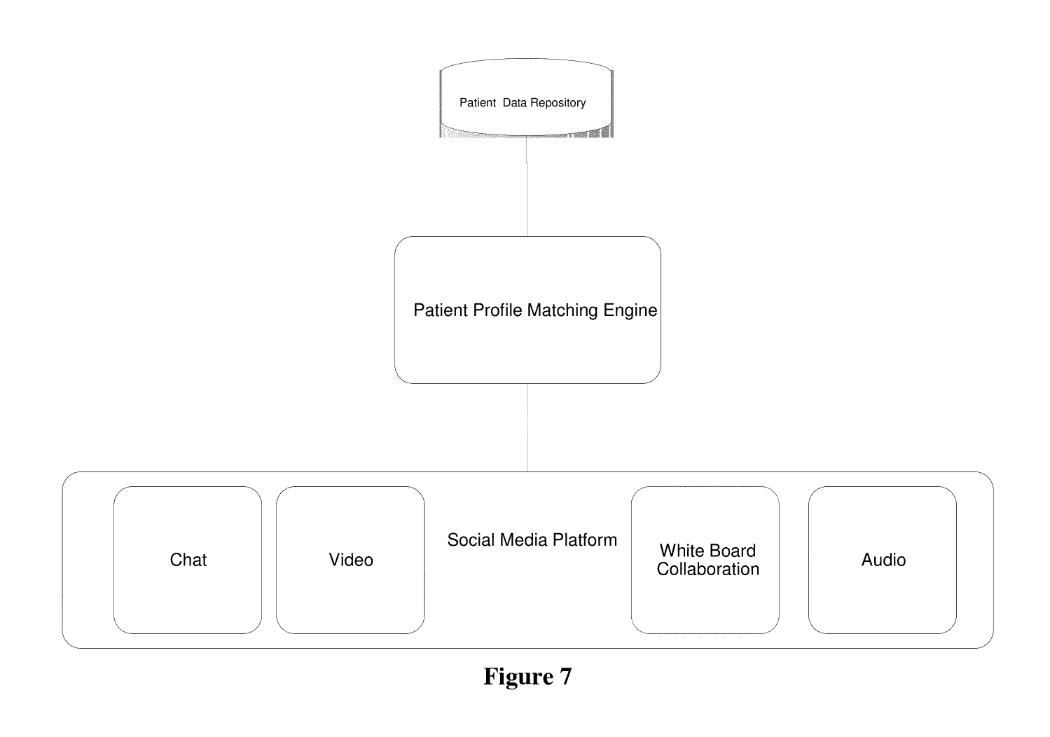

The method for doing so, as depicted in FIG. 7, begins with a patient accessing the patient filtration server. This service essentially extracts the patient's data from the database within the cancer registry platform and utilizes the similarity engine to cross reference that patient's data with all the structured and unstructured data within the cancer registry database. When similarities in demographic information and symptoms/medical condition are detected, the patient is provided with the profile of other individuals with similar profiles.

### Researchers Services

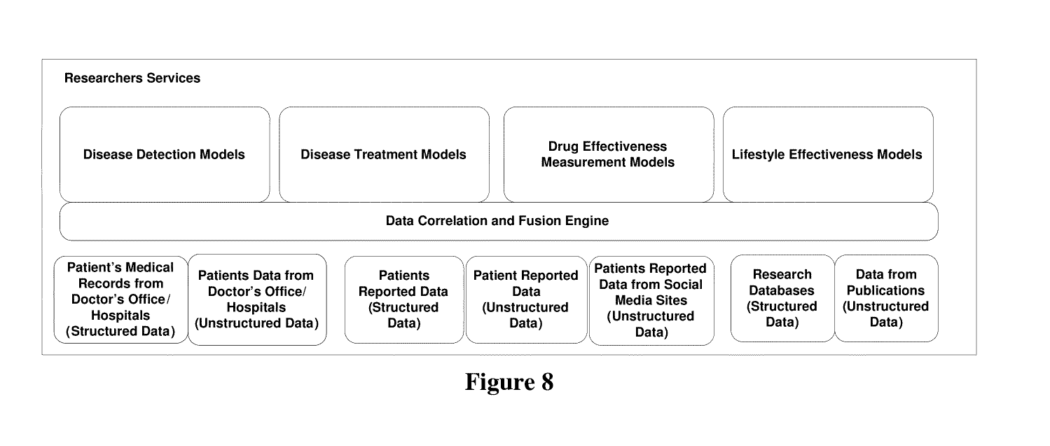

As noted before, the wealth of data stored within this platform provides an unprecedented opportunity for researchers to observe, analyze and measure the development of diseases. The platform will contain, as depicted in FIG. 8, analytics through the data correlation and fusion engine that compile the patient and physician data to construct epidemiological models on a scale that will allow for the faster detection of epidemic developments, spurning both new research and a quicker medical response.

The data in the system also can illustrate the effectiveness of drug and pharmaceutical treatments. As patients and physicians report medicinal information along with their medical conditions, the data engine can illustrate the side effects and the effectiveness of drugs among a population much larger than any test group or clinical study.

As new research illustrates how certain treatment models affect disease recovery, the patients' response to the lifestyle recommendations shed light on the effectiveness of the recommendations and can point to new areas of research that can be explored.

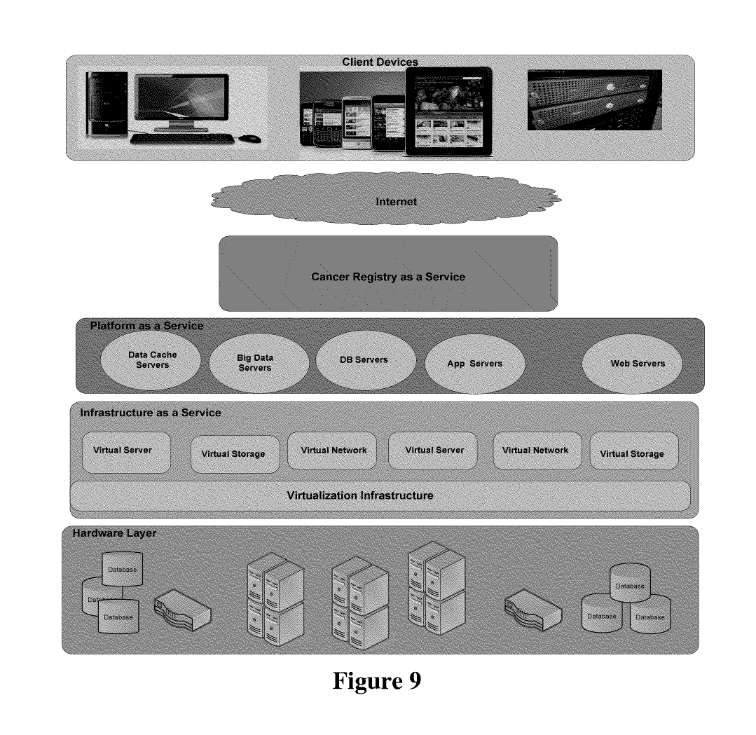

### Technical Architecture (FIG. 9)

Infrastructure as a Service (IaaS):The Medical Registry such as the Cancer Registry System will be hosted on industry proven cloud platform such as Amazon cloud. This will allow for increasing computing capacity through virtualization. This will enable the registry platform to have unlimited amount of computing capacity as the demand increases.

Platform as a Service (PaaS):The Medical Registry such as the Cancer registry system will be developed on standard platforms hosted by cloud providers. To begin the platform will be developed on open source platforms including as Apache Web Servers, Apache Tomcat, and Postgres databases. In addition, it will fully utilize the latest distributed computing platforms such as Apache Hadope hosted on Amazon EC2 cloud.

Software as a Service (SaaS):The Medical Registry such as the Cancer registry system will be architected and designed from the ground up as Software as a Service so that multiple users groups and segments can share the same software without encountering any issues of privacy and security.

What is claimed is:

1. A computer implemented system for correlating medical data, the system comprising:
a module configured to collect patient inputted data provided by a patient;
a module configured to collect data from an existing data bank;
a storage medium for storing data collected from a plurality of modules;
at least one processor configured to correlate the patient inputted data with data from one or more databases.

2. The system of claim 1, further comprising a module configured to collect a physician and/or other healthcare provider inputted data provided by a physician and other/or other healthcare provider.

3. The system of claim 2, wherein the at least one processor is further configured to correlate the patient inputted data with the physician and/or other healthcare provider inputted data.

4. The system of claim 1, wherein the existing data bank includes data from clinical trials.

5. The system of claim 1, wherein a social network environment is configured to allow a plurality of patients to interact and collaborate with each other.

6. The system of claim 1, wherein the system is configured to provide personalized recommendations to patients on lifestyle patterns.

7. The system of claim 6, wherein the lifestyle patterns include diet, exercise and stress relief.

8. The system of claim 1, wherein the system is configured to provide early disease diagnosis based on correlation between data provided by a patient and data available on an existing data bank.

9. The system of claim 2, wherein the physician and/or other healthcare provider inputted data include symptoms.

10. The system of claim 1, wherein the system is configured to filter out undesirable content before correlating patient data from a plurality of data sources.

11. The system of claim 10, wherein the system is further configured to learn desirability of information based on past history.

12. The system of claim 1, further comprising a module configured for audio and/or visual data input and/or output.

13. A tangible non-transitory computer readable medium comprising computer executable instructions executable by one or more processors for: implementing one or more operations in a computer implemented system for correlating medical data, the system comprising:
a module configured to collect patient inputted data provided by a patient;
a module configured to collect data from an existing data bank;
a storage medium for storing data collected from a plurality of modules;
at least one processor configured to correlate the patient inputted data with data from one or more databases.

14. The tangible non-transitory computer readable of claim 13, further comprising a module configured to collect a physician and/or other healthcare provider inputted data provided by a physician and other/or other healthcare provider.

15. The system of claim 14, wherein the at least one processor is further configured to correlate the patient inputted data with the physician and/or other healthcare provider inputted data.

16. A method comprising implementing one or more operations in a computer implemented system for correlating medical data, the system comprising:
a module configured to collect patient inputted data provided by a patient;
a module configured to collect data from an existing data bank;
a storage medium for storing data collected from a plurality of modules;
at least one processor configured to correlate the patient inputted data with data from one or more databases.

17. The method of claim 16, further comprising a module configured to collect a physician and/or other healthcare provider inputted data provided by a physician and other/or other healthcare provider.

18. The method of claim 17, wherein the at least one processor is further configured to correlate the patient inputted data with the physician and/or other healthcare provider inputted data.
